(19) United States
(12) Patent Application Publication
(10) Pub. No.: US 2026/0036716 A1
(43) Pub. Date: Feb. 5, 2026

(54) METHOD FOR IDENTIFYING POTENTIAL SUPERCOOLED WATER ZONE THROUGH SATELLITE-BORNE MULTI-PARAMETER ENSEMBLE

(71) Applicant: Weather Modification Center, China Meteorological Administration, Beijing (CN)

(72) Inventors: Miao Cai, Beijing (CN); Jianjun Ou, Shanghai (CN); Yuquan Zhou, Beijing (CN); Qi Li, Beijing (CN); Fan Yang, Beijing (CN); Jietai Mao, Beijing (CN)

(21) Appl. No.: 19/253,948

(22) Filed: Jun. 29, 2025

(30) Foreign Application Priority Data
Jul. 30, 2024 (CN) 202411026141.0

(51) Int. Cl. G01W 1/14; G01S 13/95

(52) U.S. Cl. CPC G01W 1/14; G01S 13/955

(57) ABSTRACT

A method for identifying a potential supercooled water zone through a satellite-borne multi-parameter ensemble includes: acquiring reference data on potential supercooled water zone identification, collecting parameter data, and pre-processing the reference data and the parameter data; grouping based on distribution features of the parameter data to obtain interval data, and performing feature selection of the parameter data based on the reference data and the interval data according to a cumulative frequency crossover method to obtain an influencing parameter; voting based on the influencing parameter to identify a potential supercooled water zone, and calculating a probability of supercooled water to obtain identification data; establishing a potential supercooled water zone identification model based on the identification data, and optimizing the potential supercooled water zone identification model using the reference data; and inputting data into the potential supercooled water zone identification model to obtain identification results.

### CROSS-REFERENCE TO RELATED APPLICATION

This application claims priority of Chinese Patent Application No. 202411026141.0, filed on Jul. 30, 2024, the entire contents of which are incorporated herein by reference.

### TECHNICAL FIELD

The present disclosure relates to the technical field of remote sensing, and in particular to a method for identifying a potential supercooled water zone through a satellite-borne multi-parameter ensemble.

### BACKGROUND

When an ambient temperature is below 0° C. in a natural environment, some liquid droplets in clouds remain unfrozen but exist in a supercooled liquid state, which is referred to as the phenomenon of supercooled water. The presence of supercooled water significantly impacts cold cloud seeding in weather modification and aircraft flight safety.

Methods for supercooled water identification based on satellite-borne passive optical remote sensing data can be divided into three types according to spectral ranges of satellite sounding: using thermal infrared bands to identify cloud phases, using visible light and near-infrared bands to identify cloud phases, and combining visible light, near-infrared bands and thermal infrared bands to identify cloud phases, that is, first distinguishing ice and water according to a relationship between a brightness temperature and a brightness temperature difference, alternatively using a radiative transfer equation to calculate a β factor (an optical depth ratio) for correction, and finally identifying supercooled water according to a cloud top temperature (CTT). Supercooled water can be identified based on the CTT.

Methods of the prior art for supercooled water identification mainly rely on satellite-borne remote sensing data, and have defects such as low identification accuracy and quantitative analysis failure.

### SUMMARY

An objective of the present disclosure is to provide a method for identifying a potential supercooled water zone through a satellite-borne multi-parameter ensemble.

To achieve the above objective, the present disclosure adopts the following technical solution:

The method of the present disclosure includes the following steps:
acquiring reference data on potential supercooled water zone identification from an active remote sensing satellite, collecting parameter data from a geostationary meteorological satellite, and pre-processing the reference data and the parameter data;
grouping based on distribution features of the parameter data to obtain interval data, and performing feature selection of the parameter data based on the reference data and the interval data according to a cumulative frequency crossover method to obtain an influencing parameter;
voting based on the influencing parameter to identify a potential supercooled water zone, and calculating a probability of supercooled water to obtain identification data;
establishing a potential supercooled water zone identification model based on the identification data, and optimizing the potential supercooled water zone identification model using the reference data; and
inputting data to be identified into the potential supercooled water zone identification model to obtain identification results.

Further, a method for acquiring reference data on potential supercooled water zone identification from an active remote sensing satellite, collecting parameter data from a geostationary meteorological satellite, and pre-processing the reference data and the parameter data, includes:
the active remote sensing satellite carries a polarized laser radar and an infrared imager, the polarized laser radar is used to identify a phase state of cloud, the infrared imager is used to identify a temperature of cloud, identification data is obtained based on the phase state and temperature of cloud, the phase state of cloud in the identification data includes a liquid phase and an ice phase, and the potential supercooled water zone includes supercooled water at a top of cloud and further includes supercooled water beneath ice in an ice-liquid mixed cloud; the parameter data includes an original channel value, a cloud product value and a sensitive channel calculation value; and
the reference data and the parameter data are matched based on geographic coordinates and timestamps.

Further, a method for grouping based on distribution features of the parameter data to obtain interval data includes:
dividing the parameter data into 10c equal-width intervals, calculating a frequency count of liquid phases and ice phases in each equal-width interval, constructing data vectors according to the frequency count of equal-width intervals, and clustering the data vectors:

$${τ}_{V} = {\sum }_{i = 1}^{n} {\sum }_{j = 1}^{c} {ϖ}_{i j}^{M} {‖ {X}_{i} - {v}_{j} ‖}^{2} + {\sum }_{j = 1}^{c} \frac{{ϱ}_{j}}{{\sum }_{i = 1}^{n} {ϖ}_{i j}} + \frac{1}{{C}_{j}} {\sum }_{i ∈ {C}_{j}} exp ( - \frac{{‖ {X}_{i} - {v}_{j} ‖}^{2}}{2 {h}^{2}} ) + λ {\sum }_{j = 1}^{c} \vert {v}_{j} \vert$$

where τ_{V} is an objective function, n is the number of data vectors, c is the number of clusters, \tilde{ω}ᵢⱼ is a membership degree of an i^{th} data vector to a j^{th} cluster, M is a fuzzy factor, [symbol] ⱼ is a fuzzy penalty coefficient of the j^{th} cluster, Xᵢ is a feature vector of the i^{th} data vector, vⱼ is a center point of the j^{th} cluster, Cⱼ is a set of data vectors in the j^{th} cluster, h is a bandwidth parameter, and λ is a regularization parameter;
a membership degree function:

$${ϖ}_{i j}^{M} = \frac{1 - \frac{{d}_{i j}}{{d}_{max}}}{{\sum }_{i = 1}^{n} ( 1 - \frac{{d}_{i j}}{{d}_{max}} )}$$

where dᵢⱼ is a Euclidean distance between the i^{th} data vector and a clustering center of the j^{th} cluster, and dₘₐₓ is a maximum Euclidean distance between any data vector and the clustering center of the j^{th} cluster;
a clustering center update formula:

$${v}_{j}^{s + 1} = \frac{{\sum }_{i = 1}^{n} {ϖ}_{i j}^{s + 1} {X}_{i}}{{\sum }_{i = 1}^{n} {ϖ}_{i j}^{s + 1}}$$

where

$${v}_{j}^{s + 1}$$

is a center point of the j^{th} cluster after s+1 iterations;
assigning a data vector to a cluster with a maximum membership degree, and evaluating clustering results:

$$= \frac{{min}_{0 < m \neq p < c} \{ {min}_{∀ {X}_{a} ∈ {C}_{m} , {X}_{b} ∈ {C}_{p}} \{ ‖ {X}_{a} - {X}_{b} ‖ \} \}}{{max}_{0 < p \leq c ∀} {max}_{{X}_{a} , {X}_{b} ∈ {C}_{p}} \{ ‖ {X}_{a} - {X}_{b} ‖ \}}$$

where [symbol] is a clustering result score, and Xₐ and X_{b} are data vectors in an m^{th} cluster and a p^{th} cluster.

Further, a method for performing feature selection of the parameter data based on the reference data and the interval data according to a cumulative frequency crossover method to obtain an influencing parameter, includes:
dividing the ice phase and liquid phase of the parameter data according to the reference data, grouping the parameter data according to the interval data, and counting data points of the ice phase and liquid phase in each group to obtain a frequency count; and calculating a ratio of the frequency count to a total number of data points to obtain a frequency, accumulating the frequency of each group to obtain a cumulative frequency, and accumulating the frequency count of each group to obtain a cumulative frequency count;
obtaining a parameter threshold and crossover frequency for ice-water determination according to distribution of crossover points based on a cumulative ice-water frequency of the parameter data, and regarding the parameter data with the crossover frequency of less than 25% or greater than 75% as an influencing parameter for distinguishing the ice phase and water phase of cloud.

Further, a method for voting based on the influencing parameter to identify a potential supercooled water zone, and calculating a probability of supercooled water to obtain identification data, includes:
when a value of cloud mask (CLM) in the cloud product value is 0 and data on the cloud top temperature (CTT) is available, it indicates presence of a cloudy zone, otherwise it is identified as a cloud-free zone;
for the influencing parameter, when the CTT is below 0° C. and a cloud top is identified to have a liquid phase according to the parameter threshold, it indicates that supercooled water exists at the cloud top or supercooled water exists in the cloud, and in this case, a voting value of 1 is assigned, otherwise a voting value of −1 is assigned;
voting results are accumulated to obtain a voting value, and when the voting value is greater than 0, it is identified as a potential supercooled water zone, otherwise it is identified as a non-potential supercooled water zone;
a probability of supercooled water is calculated based on the voting value:

$${P}_{gl} = \frac{V + {n}^{′}}{2 n} \times 100 \%$$

where V is a voting value, and n′ is the number of influencing parameters; and
the identification data include results of identifying the potential supercooled water zone and the probability of supercooled water.

Further, a method for establishing a potential supercooled water zone identification model based on the identification data includes:
dividing influencing parameters into a training set and a validation set, using the identification data as dependent variables of the training set to learn a mapping mode between the influencing parameters and the identification data, and establishing the potential supercooled water zone identification model:
through nonlinear mapping, the influencing parameters as independent variables are mapped into a high-dimensional feature space, and a linear regression function is as follows:

$$g ( x ) = {θ}^{T} φ ( x ) + c$$

where θ is a weight vector, T represents transposition, φ(x) is a mapping function of an independent variable x, and c is a bias;
a quadratic programming equation:

$$min {D}_{θ , c , v , {v}^{*}} = \frac{1}{2} {θ}^{T} θ + λ {\sum }_{k = 1}^{n} ( {v}_{k} + {v}_{k}^{*} )$$

$$\{ \begin{matrix}{k}_{} - ( {θ}^{T} φ ( {x}_{k} ) + c ) ⩽ γ + {v}_{k} + {η}_{k} , {v}_{k} ⩾ 0 \\ ( {θ}^{T} {x}_{k} + c ) - {k}_{} ⩽ τ + {v}_{k}^{*} + {η}_{k}^{*} , {v}_{k}^{*} ⩾ 0\end{matrix}$$

where λ is a penalty coefficient, k is an index of sample in the training set, n is the number of samples in the training set, νₖ and

$${v}_{k}^{*}$$

are slack adjustment variables, [symbol] ₖ is a dependent variable γ is a loss function, and ηₖ is a noise term;
a Lagrangian objective function:

$$min {D}_{\hat{δ} , {δ}^{*}} = \frac{1}{2} {\sum }_{j = 1}^{n} {\sum }_{g = 1}^{n} {R}_{j , g} ( {δ}_{j} - {δ}_{j}^{*} ) ( {δ}_{g} - {δ}_{g}^{*} ) + γ {\sum }_{j = 1}^{n} ( {δ}_{j} + {δ}_{j}^{*} ) - {\sum }_{j = 1}^{n} {j}_{} ( {δ}_{j} - {δ}_{j}^{*} )$$

where δ and δ* are solutions of the Lagrangian objective function, j and g are indices of samples in the training set, and R_{j,g} is a kernel function F(φ(xⱼ), φ(x_{g})); and
a decision function:

$$f ( x ) = {\sum }_{k = 1}^{n} ( {δ}_{k} - {δ}_{k}^{*} ) F ( φ ( {x}_{k} ) , φ ( x ) ) + c$$

the reference data is used as a label of the validation set to optimize the potential supercooled water zone identification model.

Further, a method for optimizing the potential supercooled water zone identification model using the reference data includes:
model parameters of the potential supercooled water zone identification model are used as particles for optimization, and a position of each particle in a search space is represented by Xᵢ=(xᵢ₁, xᵢ₂, . . . , xᵢₙ), where n is a dimension of the search space, and x_{id} denotes position information of the particle in a d^{th} dimension;
an acting force between two particles in the d^{th} dimension at a moment t is expressed as follows:

$${F}_{ij}^{d} ( t ) = \frac{{f}_{i} ( t )}{{f}_{j} ( t )} \cdot G ( t ) \frac{{M}_{pi} ( t ) {M}_{aj} ( t )}{{R}_{ij} ( t ) + ε} ( {x}_{j}^{d} ( t ) - {x}_{i}^{d} ( t ) )$$

where fᵢ(t) and fⱼ(t) are fitness values of an i^{th} particle and a j^{th} particle, the fitness value reflects an accuracy of the potential supercooled water zone identification model, G(t) is a universal gravitational constant at the moment t,

$$G ( t ) = {G}_{0}^{- α t / T} ,$$

where G₀ is an initial gravitational constant, α and T are parameters that control gravitational variations, Mₚᵢ(t) and Mₐⱼ(t) represent masses of the i^{th} particle and the j^{th} particle at the moment t, Rᵢⱼ(t) is a Euclidean distance between the i^{th} particle and the j^{th} particle at the moment t, ε is a constant that ensures that a denominator is not zero, and a calculation formula for Rᵢⱼ(t) is as follows:

$${R}_{ij} ( t ) = \sqrt{{\sum }_{d = 1}^{n} {( {x}_{i}^{d} ( t ) - {x}_{j}^{d} ( t ) )}^{2}}$$

where n is the dimension of the search space, and

$${x}_{i}^{d} ( t ) and {x}_{j}^{d} ( t )$$

denote positions of the i^{th} particle and the j^{th} particle in the d^{th} dimension;
a resultant force acting on the i^{th} particle in the d^{th} dimension is expressed as follows:

$${F}_{d} ( t ) = {\sum }_{j = 1 , j \neq i}^{N} G ( t ) \frac{{M}_{pi} ( t ) {M}_{aj} ( t )}{{R}_{ij} ( t ) + ε} ( {x}_{j}^{d} ( t ) - {x}_{i}^{d} ( t ) )$$

particle acceleration update is expressed as follows:

$${a}_{d} ( t ) = \frac{{F}_{d} ( t )}{{M}_{pi} ( t )} + η \cdot noise ( t ) \cdot {v}_{d} ( t + 1 )$$

where a represents an acceleration, v represents a velocity, η represents a noise intensity, and noise(t) is a random number in an interval [−1,1];
formulas for particle velocity and position update are as follows:

$${v}_{d} ( t + 1 ) = {v}_{d} ( t ) + {a}_{d} ( t ) \cdot Δ t$$

$${x}_{d} ( t + 1 ) = {x}_{d} ( t ) + {v}_{d} ( t + 1 ) \cdot Δ t$$

where Δt is a time step;
a particle mass is calculated as follows:

$${M}_{pi} ( t ) = \frac{{f}_{i} ( t ) - w ( t )}{b ( t ) - w ( t )} ( 1 + λ \cdot learning ( t ) ) ,$$

$$learning ( t ) = exp ( - β \cdot \frac{{‖ {X}_{i} ( t ) - {X}_{i}^{best} ‖}^{2}}{{σ}^{2}} )$$

where w(t) is a minimum fitness value of particles in a population, b(t) is a maximum fitness value of particles in a population, λ is a weight of a learning mechanism, learning(t) is an adaptive function based on historical performance of particles, Xᵢ(t) denotes a position of the i^{th} particle at a current moment, Xᵢ^{best} denotes an optimal position of the i^{th} particle in history, β is a parameter that controls a learning speed, and σ is a scaling factor; and
the particles are iteratively optimized until the accuracy of the potential supercooled water zone identification model reaches 85%.

In a second aspect, an electronic device is further provided in an example of the present disclosure, including:
a processor; and a memory configured to store computer-executable instructions, where when the executable instructions are executed, the processor implements the method steps described in the first aspect.

In a third aspect, a computer-readable storage medium is further provided in an example of the present disclosure, the computer-readable storage medium stores one or more programs, and when the one or more programs are executed by an electronic device including a plurality of applications, the electronic device executes the method steps described in the first aspect.

The present disclosure features the following beneficial effects:

The present disclosure provides a method for identifying a potential supercooled water zone through a satellite-borne multi-parameter ensemble, and compared with the prior art, the present disclosure has the following technical effects:

Real-time and automated: highly automated and real-time execution of algorithm effectively reduces the burden of manual monitoring, ensures the timeliness and continuity of data processing, and provides a timely decision-making basis for artificial rainfall operations;
improved identification accuracy: by comprehensively utilizing satellite-borne multi-parameter data, the present disclosure enables to more accurately identify a potential supercooled water zone, which not only takes into account limitations of single parameters, but also significantly improves the accuracy of multi-parameter ensemble identification; and
flight safety assurance: accurate identification of a potential supercooled water zone is of great significance to flight safety, and the present disclosure preemptively predicts the presence of supercooled water and aircraft icing potential in the aircraft operation area according to the changes in the supercooled water probability, and directs the aircraft to leave the cloud and de-ice through air-ground communication and real-time aircraft icing monitoring, thereby ensuring the safety of aircraft operations.

### BRIEF DESCRIPTION OF THE DRAWINGS

FIG. 1 is a flowchart of steps of a method for identifying a potential supercooled water zone through a satellite-borne multi-parameter ensemble according to the present disclosure;

FIG. 2 illustrates three scenarios of a potential supercooled water zone;

FIG. 3A illustrates a R1_37-ice-water frequency distribution;

FIG. 3B illustrates an ice-water frequency count distribution;

FIG. 3C illustrates an ice-water cumulative frequency distribution;

FIG. 3D illustrates an ice-water cumulative frequency count distribution;

FIG. 4 is a flowchart of identifying a potential supercooled water zone through a satellite-borne multi-parameter ensemble; and

FIG. 5 is a schematic structural diagram of an electronic device in an example of the specification of the present disclosure.

### DETAILED DESCRIPTIONS OF THE EMBODIMENTS

The present disclosure will be further described below in conjunction with specific examples, and illustrative examples and descriptions of the present disclosure are intended to explain the present disclosure, but are not intended to limit the present disclosure.

A method for identifying a potential supercooled water zone through a satellite-borne multi-parameter ensemble according to the present disclosure includes the following steps:

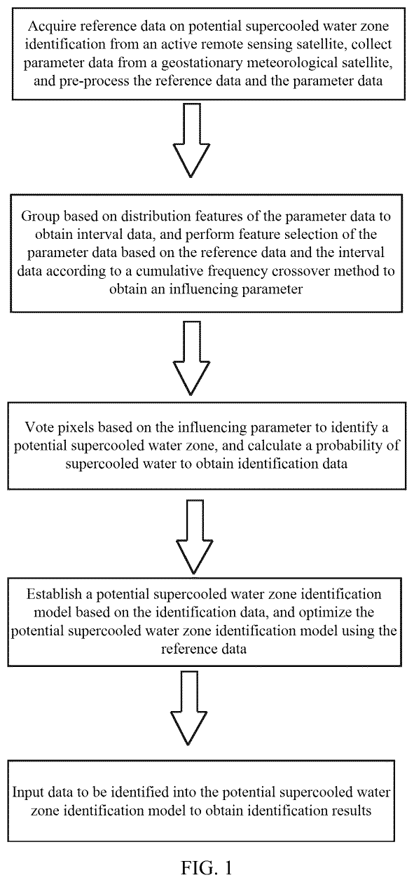

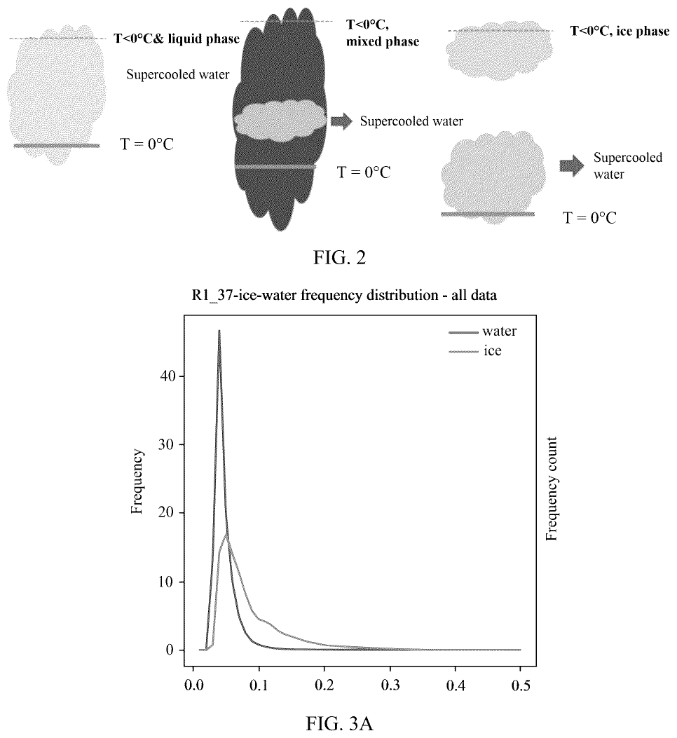

As shown in FIG. 1, in this example, the following steps are included:
acquire reference data on potential supercooled water zone identification from an active remote sensing satellite, collect parameter data from a geostationary meteorological satellite, and pre-process the reference data and the parameter data;
in actual assessment, a potential supercooled water zone is shown in FIG. 2, where a mixed phase of cloud contains both a liquid phase and an ice phase, an active remote sensing satellite selected is a CALIPSO satellite, a geostationary meteorological satellite is a FY4A satellite, and parameters of the FY4A satellite include: cloud product parameters: CTH, CTT, CTP, CPD_CER, CPD_COT, CPD_LWP, CPD_IWP; original channel parameters: R0_47, R0_65, R0_83, R1_37, R1_61, R2_22, BT3_72a, BT3_72b, BT6_25, BT7_10, BT8_50, BT10_8, BT12_0, BT13_5; and sensitive channel calculation parameters: R222b137, R161b137, R222b161, R161d137, R222d161, R222d137, BTD85_11, BTD11_12;
group based on distribution features of the parameter data to obtain interval data, and perform feature selection of the parameter data based on the reference data and the interval data according to a cumulative frequency crossover method to obtain an influencing parameter;
in actual assessment, a value of c is 4, and influencing parameters, parameter thresholds, and crossover frequencies are as follows:

| Influencing | Parameter | Crossover |
|---|---|---|
| parameter | threshold | frequency |
| FY4_CTT | 260.17 | 24.74 |
| R1.37 | 0.05 | 81.45 |
| R1.61 | 0.24 | 24.90 |
| BT3.72a | 293.89 | 22.97 |
| BT3.72b | 293.84 | 23.29 |
| BT6.25 | 235.05 | 23.05 |
| BT7.10 | 245.64 | 21.33 |
| R2.22/R1.37 | 3.67 | 18.62 |
| R1.61/R1.37 | 5.01 | 18.41 |
| R1.61-R1.37 | 0.19 | 21.15 |
| R2.22-R1.61 | −0.03 | 85.26 |
| R2.22-R1.37 | 0.13 | 22.90 |

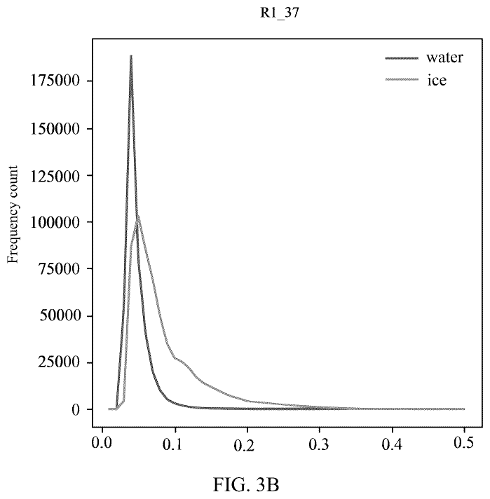

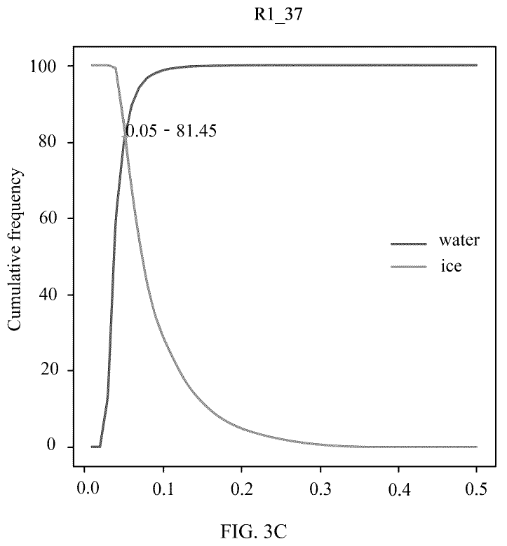

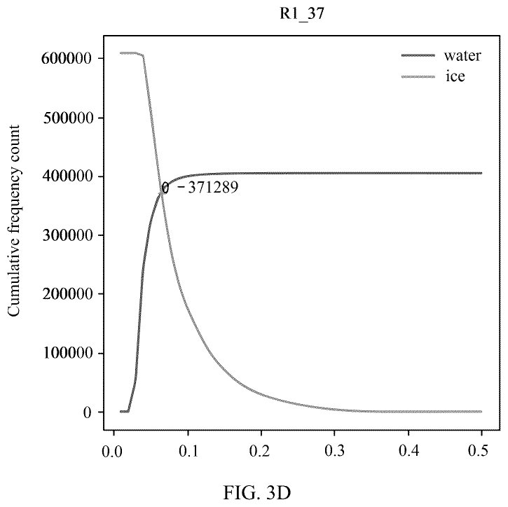

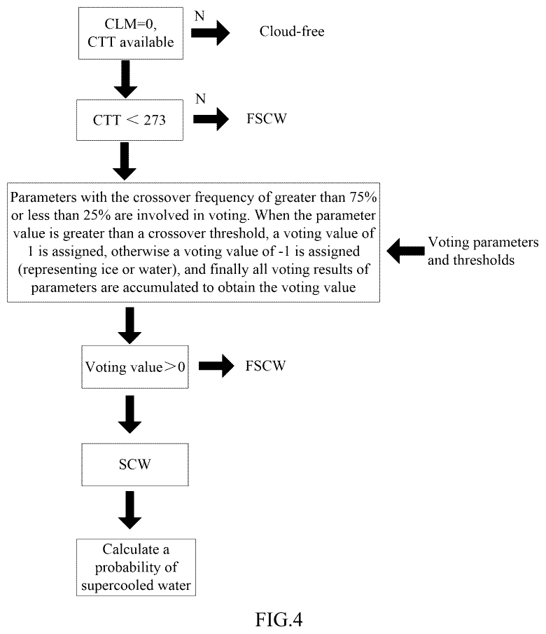

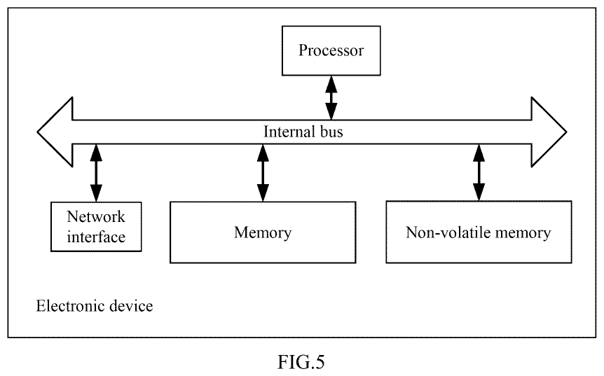

An ice-water frequency and frequency count distribution at the reflectivity of 1.37 μm monitored by the FY-4A satellite is shown in FIG. 3A and FIG. 3B, where a top-left corner indicates a frequency distribution, a top-right corner indicates a frequency count distribution, a bottom-left corner indicates a cumulative crossover frequency distribution, a bottom-right corner indicates a cumulative crossover frequency count distribution, an ice-phase reflectivity value is larger than a liquid-phase value, and cumulative frequency distribution curves of ice and water are intersected at a reflectivity of 0.05 and a frequency of 81.45%. This indicates that when an ice-water determination threshold is 0.05, an accuracy of ice-water determinations reaches up to 81.45%;
vote based on the influencing parameter to identify a potential supercooled water zone, and calculate a probability of supercooled water to obtain identification data;
in practical applications, a process of identifying a potential supercooled water zone through a satellite-borne multi-parameter ensemble is shown in FIG. 4, where FSCW represents a non-potential supercooled water zone and SCW represents a potential supercooled water zone;
establish a potential supercooled water zone identification model based on the identification data, and optimize the potential supercooled water zone identification model using the reference data; and
input data to be identified into the potential supercooled water zone identification model to obtain identification results.

In this example, a method for acquiring reference data on potential supercooled water zone identification from an active remote sensing satellite, collecting parameter data from a geostationary meteorological satellite, and pre-processing the reference data and the parameter data, includes:
the active remote sensing satellite carries a polarized laser radar and an infrared imager, the polarized laser radar is used to identify a phase state of cloud, the infrared imager is used to identify a temperature of cloud, identification data is obtained based on the phase state and temperature of cloud, the phase state of cloud in the identification data includes a liquid phase and an ice phase, and the potential supercooled water zone includes supercooled water at a top of cloud and further includes supercooled water beneath ice in an ice-liquid mixed cloud; the parameter data includes an original channel value, a cloud product value and a sensitive channel calculation value; and
the reference data and the parameter data are matched based on geographic coordinates and timestamps.

In this example, a method for grouping based on distribution features of the parameter data to obtain interval data includes:
divide the parameter data into 10c equal-width intervals, calculate a frequency count of liquid phases and ice phases in each equal-width interval, construct data vectors according to the frequency count of equal-width intervals, and cluster the data vectors:

$${τ}_{V} = {\sum }_{i = 1}^{n} {\sum }_{j = 1}^{c} {ϖ}_{i j}^{M} {‖ {X}_{i} - {v}_{j} ‖}^{2} + {\sum }_{j = 1}^{c} \frac{{ϱ}_{j}}{{\sum }_{i = 1}^{n} {ϖ}_{i j}} + \frac{1}{{C}_{j}} {\sum }_{i ∈ {C}_{j}} exp ( - \frac{{‖ {X}_{i} - {v}_{j} ‖}^{2}}{2 {h}^{2}} ) + λ {\sum }_{j = 1}^{c} \vert {v}_{j} \vert$$

where τ_{V} is an objective function, n is the number of data vectors, c is the number of clusters, \tilde{ω}ᵢⱼ is a membership degree of an i^{th} data vector to a j^{th} cluster, M is a fuzzy factor, [symbol] ⱼ is a fuzzy penalty coefficient of the j^{th} cluster, Xᵢ is a feature vector of the i^{th} data vector, vⱼ is a center point of the j^{th} cluster, Cⱼ is a set of data vectors in the j^{th} cluster, h is a bandwidth parameter, and λ is a regularization parameter;
a membership degree function:

$${ϖ}_{ij}^{M} = \frac{1 - \frac{{d}_{ij}}{{d}_{ma x}}}{{\sum }_{i = 1}^{n} ( 1 - \frac{{d}_{ij}}{{d}_{ma x}} )}$$

where dᵢⱼ is a Euclidean distance between the i^{th} data vector and a clustering center of the j^{th} cluster, and dₘₐₓ is a maximum Euclidean distance between any data vector and the clustering center of the j^{th} cluster;
a clustering center update formula:

$${v}_{j}^{s + 1} = \frac{{\sum }_{i = 1}^{n} {ϖ}_{i j}^{s + 1} {X}_{i}}{{\sum }_{i = 1}^{n} {ϖ}_{i j}^{s + 1}}$$

where

$${v}_{j}^{s + 1}$$

is a center point of the j^{th} cluster after s+1 iterations;
assign a data vector to a cluster with a maximum membership degree, and evaluate clustering results:

$$= \frac{{min}_{0 < m \neq p < c} \{ {min}_{∀ {X}_{a} ∈ {C}_{m} , {X}_{b} ∈ {C}_{p}} \{ ‖ {X}_{a} - {X}_{b} ‖ \} \}}{{min}_{0 < p \leq c} {min}_{∀ {X}_{a} , {X}_{b} ∈ {C}_{p}} \{ ‖ {X}_{a} - {X}_{b} ‖ \}}$$

where [symbol] is a clustering result score, and Xₐ and X_{b} are data vectors in an m^{th} cluster and a p^{th} cluster.

In this example, a method for performing feature selection of the parameter data based on the reference data and the interval data according to a cumulative frequency crossover method to obtain an influencing parameter, includes:
divide the ice phase and liquid phase of the parameter data according to the reference data, group the parameter data according to the interval data, and count data points of the ice phase and liquid phase in each group to obtain a frequency count; and calculate a ratio of the frequency count to a total number of data points to obtain a frequency, accumulate the frequency of each group to obtain a cumulative frequency, and accumulate the frequency count of each group to obtain a cumulative frequency count; and
obtain a parameter threshold and crossover frequency for ice-water determination according to distribution of crossover points based on a cumulative ice-water frequency of the parameter data, and regard the parameter data with the crossover frequency of less than 25% or greater than 75% as an influencing parameter for distinguishing the ice phase and water phase of cloud.

In this example, a method for voting based on the influencing parameter to identify a potential supercooled water zone, and calculating a probability of supercooled water to obtain identification data, includes:
when a value of cloud mask (CLM) in the cloud product value is 0 and data on the cloud top temperature (CTT) is available, it indicates presence of a cloudy zone, otherwise it is identified as a cloud-free zone;
for the influencing parameter, when the CTT is below 0° C. and a cloud top is identified to have a liquid phase according to the parameter threshold, it indicates that supercooled water exists at the cloud top or supercooled water exists in the cloud, and in this case, a voting value of 1 is assigned, otherwise a voting value of −1 is assigned;
voting results are accumulated to obtain a voting value, and when the voting value is greater than 0, it is identified as a potential supercooled water zone, otherwise it is identified as a non-potential supercooled water zone;
a probability of supercooled water is calculated based on the voting value:

$${P}_{gl} = \frac{V + {n}^{′}}{2 {n}^{′}} \times 100 \%$$

where V is a voting value, and n′ is the number of influencing parameters; and
the identification data include results of identifying the potential supercooled water zone and the probability of supercooled water.

In this example, a method for establishing a potential supercooled water zone identification model based on the identification data includes:
divide influencing parameters into a training set and a validation set, use the identification data as dependent variables of the training set to learn a mapping mode between the influencing parameters and the identification data, and establish the potential supercooled water zone identification model:
through nonlinear mapping, the influencing parameters as independent variables are mapped into a high-dimensional feature space, and a linear regression function is as follows:

$$g ( x ) = {θ}^{T} φ ( x ) + c$$

where θ is a weight vector, T represents transposition, φ(x) is a mapping function of an independent variable x, and c is a bias;
a quadratic programming equation:

$$\begin{matrix}min {D}_{θ , c , v , {v}^{*}} = \frac{1}{2} {θ}^{T} θ + λ {\sum }_{k = 1}^{n} ( {v}_{k} + {v}_{k}^{*} ) \\ \{ \begin{matrix}{k}_{} - ( {θ}^{T} φ ( {x}_{k} ) + c ) ⩽ γ + {v}_{k} + {η}_{k} , {v}_{k} ⩾ 0 \\ ( {θ}^{T} {x}_{k} + c ) - {k}_{} ⩽ τ + {v}_{k}^{*} + {η}_{k}^{*} , {v}_{k}^{*} ⩾ 0\end{matrix}\end{matrix}$$

where λ is a penalty coefficient, k is an index of sample in the training set, n is the number of samples in the training set, νₖ and

$${v}_{k}^{*}$$

are stack adjustment variables, [symbol] ₖ is a dependent variable, γ is a loss function, and ηₖ is a noise term;
a Lagrangian objective function:

$$min {D}_{\hat{δ} , {δ}^{*}} = \frac{1}{2} {\sum }_{j = 1}^{n} {\sum }_{g = 1}^{n} {R}_{j , g} ( {δ}_{j} - {δ}_{j}^{*} ) ( {δ}_{g} - {δ}_{g}^{*} ) + γ {\sum }_{j = 1}^{n} ( {δ}_{j} + {δ}_{j}^{*} ) - {\sum }_{j = 1}^{n} {j}_{} ( {δ}_{j} - {δ}_{j}^{*} )$$

where δ and δ* are solutions of the Lagrangian objective function, j and g are indices of samples in the training set, and R_{i,g} is a kernel function F(φ(xⱼ), φ(x_{g}));
a decision function:

$$f ( x ) = {\sum }_{k = 1}^{n} ( {δ}_{k} - {δ}_{k}^{*} ) F ( φ ( {x}_{k} ) , φ ( x ) ) + c$$

the reference data is used as a label of the validation set to optimize the potential supercooled water zone identification model.

In this example, a method for optimizing the potential supercooled water zone identification model using the reference data includes:
model parameters of the potential supercooled water zone identification model are used as particles for optimization, and a position of each particle in a search space is represented by Xᵢ=(xᵢ₁, xᵢ₂, . . . , Xᵢₙ), where n is a dimension of the search space, and x_{id} denotes position information of the particle in a d^{th} dimension,
an acting force between two particles in the d^{th} dimension at a moment t is expressed as follows:

$${F}_{i j}^{d} ( t ) = \frac{{f}_{i} ( t )}{{f}_{j} ( t )} \cdot G ( t ) \frac{{M}_{p i} ( t ) {M}_{a j} ( t )}{{R}_{i j} ( t ) + ε} ( {x}_{j}^{d} ( t ) - {x}_{i}^{d} ( t ) )$$

where fᵢ(t) and fᵢ(t) are fitness values of an i^{th} particle and a j^{th} particle, the fitness value reflects an accuracy of the potential supercooled water zone identification model, G(t) is a universal gravitational constant at the moment t,

$$G ( t ) = {G}_{0}^{- α t / T} ,$$

where G₀ is an initial gravitational constant, α and T are parameters that control gravitational variations, Mₚᵢ(t) and Mₐⱼ(t) represent masses of the i^{th} particle and the j^{th} particle at the moment t, Rᵢⱼ(t) is a Euclidean distance between the i^{th} particle and the j^{th} particle at the moment t, ε is a constant that ensures that a denominator is not zero, and a calculation formula for Rᵢⱼ(t) is as follows:

$${R}_{i j} ( t ) = \sqrt{{\sum }_{d = 1}^{n} {( {x}_{i}^{d} ( t ) - {x}_{j}^{d} ( t ) )}^{2}}$$

where n is the dimension of the search space, and

$${x}_{i}^{d} ( t ) and {x}_{j}^{d} ( t )$$

denote positions of the i^{th} particle and the j^{th} particle in the d^{th} dimension;
a resultant force acting on the i^{th} particle in the d^{th} dimension is expressed as follows:

$${F}_{d} ( t ) = {\sum }_{j = 1 , j \neq i}^{N} G ( t ) \frac{{M}_{p i} ( t ) {M}_{a j} ( t )}{{R}_{i j} ( t ) + ε} ( {x}_{j}^{d} ( t ) - {x}_{i}^{d} ( t ) )$$

particle acceleration update is expressed as follows:

$${a}_{d} ( t ) = \frac{{F}_{d} ( t )}{{M}_{p i} ( t )} + η \cdot noise ( t ) \cdot {v}_{d} ( t + 1 )$$

where a represents an acceleration, v represents a velocity, η represents a noise intensity, and noise(t) is a random number in an interval [−1,1];
formulas for particle velocity and position update are as follows:

$${v}_{d} ( t + 1 ) = {v}_{d} ( t ) + {a}_{d} ( t ) \cdot Δt$$

$${x}_{d} ( t + 1 ) = {x}_{d} ( t ) + {v}_{d} ( t + 1 ) \cdot Δt$$

where Δt is a time step;
a particle mass is calculated as follows:

$${M}_{pi} ( t ) = \frac{{f}_{i} ( t ) - w ( t )}{b ( t ) - w ( t )} ( 1 + λ \cdot learning ( t ) ) , learning ( t ) = exp ( - β \cdot \frac{{‖ {X}_{i} ( t ) - {X}_{i}^{b e s t} ‖}^{2}}{{σ}^{2}} )$$

in the formulas, w(t) is a minimum fitness value of particles in a population, b(t) is a maximum fitness value of particles in a population, λ is a weight of a learning mechanism, learning(t) is an adaptive function based on historical performance of particles, Xᵢ(t) denotes a position of the i^{th} particle at a current moment,

$${X}_{i}^{b e s t}$$

denotes an optimal positon of the i^{th} particle in history, β is a parameter that controls a learning speed, and o is a scaling factor; and
the particles are iteratively optimized until the accuracy of the potential supercooled water zone identification model reaches 85%.

FIG. 5 is a schematic structural diagram of an electronic device in an example of the present disclosure. With reference to FIG. 5, at the hardware level, the electronic device includes a processor, and optionally further includes an internal bus, a network interface, and a memory. The memory may include a volatile memory, such as a high-speed random access memory (RAM), and may also include a non-volatile memory, such as at least one disk memory and the like. Of course, the electronic device may also include hardware required for other services.

The processor, the network interface and the memory may be interconnected via an internal bus, and the internal bus may be an industry standard architecture (ISA) bus, a peripheral component interconnect (PCI) bus or an extended industry standard architecture (EISA) bus, and the like. The bus can be divided into an address bus, a data bus, a control bus, and the like. For the convenience of expression, only one bidirectional arrow is used in FIG. 2, but it does not mean that there is only one bus or one type of bus.

The memory is configured for storing programs. Specifically, the program may include a program code, and the program code includes a computer operation instruction. The memory may include a volatile memory and a non-volatile memory, and provides instructions and data to the processor.

The processor reads a corresponding computer program from the non-volatile memory into the memory and then executes same, and a device for identifying a potential supercooled water zone through a satellite-borne multi-parameter ensemble is formed at the logical level. The processor executes the program stored in the memory and is specifically used to execute any of the above methods for identifying a potential supercooled water zone through a satellite-borne multi-parameter ensemble.

The method for identifying a potential supercooled water zone through a satellite-borne multi-parameter ensemble disclosed in an example shown in FIG. 1 of the present disclosure can be applied to the processor or implemented by the processor. The processor may be an integrated circuit chip with signal processing capabilities. In the implementation process, each step of the above method can be implemented by means of an integrated logic circuit of hardware in the processor or an instruction in the form of software. The above processor can be a general-purpose processor, including a central processing unit (CPU), a network processor (NP) and the like; and can also be a digital signal processor (DSP), an application-specific integrated circuit (ASIC), a field-programmable gate array (FPGA), or any other programmable logic device, a discrete gate or a transistor logic device, or a discrete hardware component, and the like. The methods, steps and logic block diagrams disclosed in the examples of the present disclosure can be implemented or executed. The general-purpose processor can be a microprocessor, or the processor can also be any conventional processor. The steps of the method disclosed in the examples of the present disclosure can be directly executed by a hardware decoding processor, or executed through a combination of hardware and software modules in the decoding processor. The software module can be located in a mature storage medium in the art such as a random access memory, flash memory, read-only memory, programmable read-only memory or electrically erasable programmable memory, register, and the like. The storage medium is located in the memory, and the processor reads information in the memory and implements the steps of the above method in combination with its hardware.

The electronic device can also execute the method for identifying a potential supercooled water zone through a satellite-borne multi-parameter ensemble shown in FIG. 1, and realizes the functions of the examples shown in FIG. 1, and the examples of the present disclosure will not be described in detail herein.

In an example of the present disclosure, a computer-readable storage medium is further provided, the computer-readable storage medium stores one or more programs, the one or more programs include instructions, and when the instructions are executed by an electronic device including a plurality of applications, any of the above methods for identifying a potential supercooled water zone through a satellite-borne multi-parameter ensemble.

A person skilled in the art should understand that the examples of the present disclosure may be provided in the form of a method, a system or a computer program product. Therefore, the present disclosure may use a form of a complete hardware example, a complete software example or an example combining software and hardware. Moreover, the present disclosure may use a form of a computer program product that is implemented on one or more computer-usable storage media (including but not limited to a disk memory, a CD-ROM, an optical memory or the like) that include the computer-usable program code.

The present disclosure is described with reference to the flowcharts and/or block diagrams of the method, the apparatus (systems), and the computer program product according to the examples of the present disclosure. It should be understood that computer program instructions may be used to implement each procedure and/or each block in the flowcharts and/or the block diagrams and a combination of a procedure and/or a block in the flowcharts and/or the block diagrams. These computer program instructions may be provided to a general-purpose computer, a dedicated computer, an embedded processor or a processor of any other programmable data processing apparatus to generate a machine, so that the instructions executed by a computer or a processor of any other programmable data processing apparatus generate a device for implementing a specific function in one or more procedures in the flowcharts and/or in one or more blocks in the block diagrams.

These computer program instructions may also be stored in a computer-readable memory that can instruct the computer or any other programmable data processing apparatus to work in a specific manner, so that the instructions stored in the computer-readable memory generate manufactured products including an instruction device. The instruction device implements a specific function in one or more procedures in the flowcharts and/or in one or more blocks in the block diagrams.

These computer program instructions may also be loaded onto a computer or any other programmable data processing apparatus, so that a series of operations and steps are performed on the computer or any other programmable apparatus, so as to generate computer-implemented processing. Therefore, the instructions executed on the computer or any other programmable apparatus provide steps for implementing a specific function in one or more processes in the flowcharts and/or in one or more blocks in the block diagrams.

In a typical configuration, a computing device includes one or more central processing units (CPUs), input/output interfaces, network interfaces, and memories.

The memory may include a non-permanent memory in a computer-readable medium, a random access memory (RAM) and/or a non-volatile memory and the like, such as a read-only memory (ROM) or a flash RAM. The memory is an example of a computer-readable medium.

Computer-readable media include permanent and non-permanent, removable and non-removable media that can be used to store information by any method or technology. Information may be computer-readable instructions, data structures, program modules, or other data. Examples of computer storage media include, but are not limited to, a phase change random access memory (PRAM), a static random access memory (SRAM), a dynamic random access memory (DRAM), any other type of random access memory (RAM), read-only memory (ROM), electrically erasable programmable read-only memory (EEPROM), flash memory or other memory technology, compact disk read-only memory (CD-ROM), digital versatile disk (DVD) or any other optical storage device, magnetic cassette, magnetic disk storage device or any other magnetic storage device, or any other non-transmission medium that can be used to store information accessible to a computing device. As defined herein, the computer-readable medium excludes transitory media, such as modulated data signals and carrier waves.

It should also be noted that the terms “including”, “comprising”, or any other variants are intended to cover the non-exclusive including, thereby making that the process, method, merchandise or apparatus comprising a series of elements comprise not only those elements but also other elements that are not listed explicitly or the inherent elements to the process, method, merchandise or apparatus. Without more restrictions, the elements defined by the sentence “including a . . . ” do not exclude the existence of other identical elements in the process, method, merchandise, or device including the elements.

A person skilled in the art should understand that the embodiments of the present application may be provided in the form of a method, a system or a computer program product. Therefore, the present application may use a form of a complete hardware embodiment, a complete software embodiment or an embodiment combining software and hardware. Moreover, the present disclosure may use a form of a computer program product that is implemented on one or more computer-usable storage media (including but not limited to a disk memory, a CD-ROM, an optical memory or the like) that include the computer-usable program code.

The foregoing descriptions are merely exemplary examples of the present disclosure, but are not intended to limit the present disclosure. Any modification, equivalent replacement or improvement derived within the spirit and principle of the present disclosure shall all fall within the protection scope of the present disclosure.

1. A method for identifying a potential supercooled water zone through a satellite-borne multi-parameter ensemble, comprising the following steps:
acquiring reference data on potential supercooled water zone identification from an active remote sensing satellite, collecting parameter data from a geostationary meteorological satellite, and pre-processing the reference data and the parameter data;
grouping based on distribution features of the parameter data to obtain interval data, and performing feature selection of the parameter data based on the reference data and the interval data according to a cumulative frequency crossover method to obtain an influencing parameter;
performing pixel-wise voting based on the influencing parameter to identify a potential supercooled water zone, and calculating a probability of supercooled water to obtain identification data;
when a value of cloud mask (CLM) in a cloud product value is 0 and data on a cloud top temperature (CTT) is available, this indicates presence of a cloudy zone, otherwise it is identified as a cloud-free zone;
for the influencing parameter, when the CTT is below 0° C. and a cloud top is identified to have a liquid phase according to a parameter threshold, this indicates that supercooled water exists at the cloud top or supercooled water exists in the cloud, and in this case, a voting value of 1 is assigned, otherwise a voting value of −1 is assigned;
voting results are accumulated to obtain a voting value, and when the voting value is greater than 0, it is identified as a potential supercooled water zone, otherwise it is identified as a non-potential supercooled water zone;
a probability of supercooled water is calculated based on the voting value:
$${P}_{gl} = \frac{V + {n}^{′}}{2 {n}^{′}} \times 100 \%$$
in the formula, V is a voting value, and n′ is the number of influencing parameters; and
the identification data comprise results of identifying the potential supercooled water zone and the probability of supercooled water;
establishing a potential supercooled water zone identification model based on the identification data, and optimizing the potential supercooled water zone identification model using the reference data; and
inputting data to be identified into the potential supercooled water zone identification model to obtain identification results.

2. The method for identifying a potential supercooled water zone through a satellite-borne multi-parameter ensemble according to claim 1, wherein a method for acquiring reference data on potential supercooled water zone identification from an active remote sensing satellite, collecting parameter data from a geostationary meteorological satellite, and pre-processing the reference data and the parameter data, comprises:
the active remote sensing satellite carries a polarized laser radar and an infrared imager, the polarized laser radar is configured to identify a phase state of cloud, the infrared imager is configured to identify a temperature of cloud, identification data is obtained based on the phase state and temperature of cloud, the phase state of cloud in the identification data comprises a liquid phase and an ice phase, and the potential supercooled water zone comprises supercooled water at a top of cloud and further comprises supercooled water beneath ice in an ice-liquid mixed cloud; the parameter data comprises an original channel value, a cloud product value and a sensitive channel calculation value; and
the reference data and the parameter data are matched based on geographic coordinates and timestamps.

3. The method for identifying a potential supercooled water zone through a satellite-borne multi-parameter ensemble according to claim 1, wherein a method for performing feature selection of the parameter data based on the reference data and the interval data according to a cumulative frequency crossover method to obtain an influencing parameter, comprises:
dividing the ice phase and liquid phase of the parameter data according to the reference data, grouping the parameter data according to the interval data, and counting data points of the ice phase and liquid phase in each group to obtain a frequency count; and calculating a ratio of the frequency count to a total number of data points to obtain a frequency, accumulating the frequency of each group to obtain a cumulative frequency, and accumulating the frequency count of each group to obtain a cumulative frequency count; and
obtaining a parameter threshold and crossover frequency for ice-water determination according to distribution of crossover points based on a cumulative ice-water frequency of the parameter data, and regarding the parameter data with the crossover frequency of less than 25% or greater than 75% as an influencing parameter for distinguishing the ice phase and water phase of cloud.

4. The method for identifying a potential supercooled water zone through a satellite-borne multi-parameter ensemble according to claim 1, wherein a method for optimizing the potential supercooled water zone identification model using the reference data comprises:
model parameters of the potential supercooled water zone identification model are used as particles for optimization, and a position of each particle in a search space is represented by Xᵢ=(xᵢ₁, xᵢ₂, . . . , Xᵢₙ), wherein n is a dimension of the search space, and x_{id} denotes position information of the particle in a d^{th} dimension;
an acting force between two particles in the d^{th} dimension at a moment t is expressed as follows:
$${F}_{i j}^{d} ( t ) = \frac{{f}_{i} ( t )}{{f}_{j} ( t )} \cdot G ( t ) \frac{{M}_{p i} ( t ) {M}_{a j} ( t )}{{R}_{i j} ( t ) + ε} ( {x}_{j}^{d} ( t ) - {x}_{i}^{d} ( t ) )$$
in the formula, fᵢ(t) and fⱼ(t) are fitness values of an i^{th} particle and a j^{th} particle, the fitness value reflects an accuracy of the potential supercooled water zone identification model, G(t) is a universal gravitational constant at the moment t,
$$G ( t ) = {G}_{0}^{- α t / T} ,$$
wherein G₀ is an initial gravitational constant, α and T are parameters that control gravitational variations, Mₚᵢ(t) and Mₐⱼ(t) represent masses of the i^{th} particle and the j^{th} particle at the moment t, Rᵢⱼ(t) is a Euclidean distance between the i^{th} particle and the j^{th} particle at the moment t, ε is a constant that ensures that a denominator is not zero, and a calculation formula for Rᵢⱼ(t) is as follows:
$${R}_{i j} ( t ) = \sqrt{{\sum }_{d = 1}^{n} {( {x}_{i}^{d} ( t ) - {x}_{j}^{d} ( t ) )}^{2}}$$
in the formula, n is the dimension of the search space, and
$${x}_{i}^{d} ( t ) and {x}_{j}^{d} ( t )$$
denote positions of the i^{th} particle and the j^{th} particle in the d^{th} dimension;
a resultant force acting on the i^{th} particle in the d^{th} dimension is expressed as follows:
$${F}_{d} ( t ) = {\sum }_{j = 1 , j \neq i}^{N} G ( t ) \frac{{M}_{p i} ( t ) {M}_{aj} ( t )}{{R}_{ij} ( t ) + ε} ( {x}_{j}^{d} ( t ) - {x}_{i}^{d} ( t ) )$$
particle acceleration update is expressed as follows:
$${a}_{d} ( t ) = \frac{{F}_{d} ( t )}{{M}_{p i} ( t )} + η \cdot noise ( t ) \cdot {v}_{d} ( t + 1 )$$
in the formula, a represents an acceleration, v represents a velocity, η represents a noise intensity, and noise(t) is a random number in an interval [−1,1];
formulas for particle velocity and position update are as follows:
$${v}_{d} ( t + 1 ) = {v}_{d} ( t ) + {a}_{d} ( t ) \cdot Δ t$$
$${x}_{d} ( t + 1 ) = {x}_{d} ( t ) + {v}_{d} ( t + 1 ) \cdot Δ t$$
in the formulas, Δt is a time step;
a particle mass is calculated as follows:
$${M}_{pi} ( t ) = \frac{{f}_{i} ( t ) - w ( t )}{b ( t ) - w ( t )} ( 1 + λ \cdot learning ( t ) ) , learning ( t ) = exp ( - β \cdot \frac{{‖ {X}_{i} ( t ) - {X}_{i}^{b e s t} ‖}^{2}}{{σ}^{2}} )$$
in the formulas, w(t) is a minimum fitness value of particles in a population, b(t) is a maximum fitness value of particles in a population, λ is a weight of a learning mechanism, learning(t) is an adaptive function based on historical performance of particles, Xᵢ(t) denotes a position of the i^{th} particle at a current moment,
$${X}_{i}^{b e s t}$$
denotes an optimal position or the i^{th} particle in history, β is a parameter that controls a learning speed, and σ is a scaling factor; and
the particles are iteratively optimized until the accuracy of the potential supercooled water zone identification model reaches 85%.

5. An electronic device, comprising: a processor; and
a memory configured to store computer-executable instructions, wherein when the executable instructions are executed, the processor implements the method according to claim 1.

6. An electronic device, comprising: a processor; and
a memory configured to store computer-executable instructions, wherein when the executable instructions are executed, the processor implements the method according to claim 2.

7. An electronic device, comprising: a processor; and
a memory configured to store computer-executable instructions, wherein when the executable instructions are executed, the processor implements the method according to claim 3.

8. An electronic device, comprising: a processor; and
a memory configured to store computer-executable instructions, wherein when the executable instructions are executed, the processor implements the method according to claim 4.

9. A computer-readable storage medium, wherein the computer-readable storage medium stores one or more programs, and when the one or more programs are executed by an electronic device comprising a plurality of applications, the electronic device executes the method according to claim 1.

10. A computer-readable storage medium, wherein the computer-readable storage medium stores one or more programs, and when the one or more programs are executed by an electronic device comprising a plurality of applications, the electronic device executes the method according to claim 2.

11. A computer-readable storage medium, wherein the computer-readable storage medium stores one or more programs, and when the one or more programs are executed by an electronic device comprising a plurality of applications, the electronic device executes the method according to claim 3.

12. A computer-readable storage medium, wherein the computer-readable storage medium stores one or more programs, and when the one or more programs are executed by an electronic device comprising a plurality of applications, the electronic device executes the method according to claim 4.
